(19) United States
(12) Patent Application Publication
(10) Pub. No.: US 2023/0134642 A1
(43) Pub. Date: May 4, 2023

(54) LIDAR SYSTEM CAPABLE OF SETTING SENSINGN AREA

(71) Applicant: Kanavi Mobility Co., Ltd., Incheon (KR)

(72) Inventors: Jae Jun YUN, Incheon (KR); Su Yeon KIM, Mokpo-si (KR); Tae Won CHONG, Incheon (KR); Jong Taek JUNG, Incheon (KR)

(21) Appl. No.: 18/146,846

(22) Filed: Dec. 27, 2022

Related U.S. Application Data
(63) Continuation of application No. PCT/KR2021/006473, filed on May 25, 2021.

(30) Foreign Application Priority Data
Jul. 13, 2020 (KR) 10-2020-0086185

(51) Int. Cl. G01S 7/48; G01S 17/10; G01S 7/4865

(52) U.S. Cl. CPC G01S 7/4808; G01S 17/10; G01S 7/4865

(57) ABSTRACT

A lidar sensor comprises a sensing area unit configured to set a sensing area in a maximum scan angle range and manage the set sensing area, a light output unit configured to output a light with a specific angle so that the light is outputted to a specific sensing area, and a sensing unit configured to sense an object in the specific sensing area by using a reflection light of the outputted light. The outputted light forms a trigger line, the sensing unit obtains a measured angle and a light arrival time of the sensed object based on the trigger line, and a minimum distance and a maximum distance from the lidar sensor to the specific sensing area are set based on the trigger line.

### CROSS-REFERENCE TO RELATED APPLICATIONS

This application is a continuation of pending PCT International Application No. PCT/KR2021/006473, which was filed on May 25, 2021, and which claims priority to Korean Patent Application No. 10-2020-0086185 filed with the Korean Intellectual Property Office on Jul. 13, 2020. The disclosures of the above patent applications are incorporated herein by reference in their entirety.

### TECHNICAL FIELD

The disclosure relates to a lidar system capable of setting freely a sensing area by a user.

### BACKGROUND ART

A lidar sensor scans usually in a predetermined angle range, and thus it is impossible to scan an area desired by a user.

### SUMMARY

The disclosure is to provide a lidar system capable of setting a sensing area by a user and monitoring the set sensing area.

A lidar sensor according to an embodiment of the disclosure includes a sensing area unit configured to set a sensing area in a maximum scan angle range and manage the set sensing area; a light output unit configured to output a light with a specific angle so that the light is outputted to a specific sensing area; and a sensing unit configured to sense an object in the specific sensing area by using a reflection light of the outputted light. Here, the outputted light forms a trigger line, the sensing unit obtains a measured angle and a light arrival time of the sensed object based on the trigger line, a minimum distance and a maximum distance from the lidar sensor to the specific sensing area is set based on the trigger line.

A viewer device according to an embodiment of the disclosure includes a sensing area designating unit configured to manage a sensing area designated by a user; a communication unit configured to transmit data concerning the designated sensing area in an orthogonal coordinate system to the lidar sensor and receive information concerning an object sensed in the sensing area from the lidar sensor; and a monitoring unit configured to monitor the sensing area based on the received information.

A lidar system of the disclosure may monitor a sensing area set by a user, and so the user may use one lidar sensor for various places and uses.

### BRIEF DESCRIPTION OF DRAWINGS

Example embodiments of the present disclosure will become more apparent by describing in detail example embodiments of the present disclosure with reference to the accompanying drawings, in which:

FIG. 1 is a view illustrating a lidar system according to an embodiment of the disclosure;

FIG. 2 is a view illustrating a process of setting an area;

FIG. 3 is a view illustrating viewer data according to an embodiment of the disclosure;

FIG. 4 and FIG. 5 are views illustrating example of area setting;

FIG. 6 is a view illustrating a method of sensing an area by using a distance;

FIG. 7 is a view illustrating an example of a buffer;

FIG. 8 is a view illustrating a process of setting plural sensing areas;

FIG. 9 is a view illustrating setting of the buffer in FIG. 8;

FIG. 10 is a view illustrating a trigger line;

FIG. 11 is a view illustrating a distance conversion process according to an embodiment of the disclosure;

FIG. 12 is a block diagram illustrating a lidar sensor according to an embodiment of the disclosure; and

FIG. 13 is a block diagram illustrating a viewer device according to an embodiment of the disclosure.

### DETAILED DESCRIPTION

In the present specification, an expression used in the singular encompasses the expression of the plural, unless it has a clearly different meaning in the context. In the present specification, terms such as “comprising” or “including,” etc., should not be interpreted as meaning that all of the elements or operations are necessarily included. That is, some of the elements or operations may not be included, while other additional elements or operations may be further included. Also, terms such as “unit,” “module,” etc., as used in the present specification may refer to a part for processing at least one function or action and may be implemented as hardware, software, or a combination of hardware and software.

The disclosure relates to a lidar system capable of setting a sensing area. A user may set and monitor a desired sensing area in a scan angle range of the lidar sensor. Accordingly, it is possible to set and monitor the sensing area with one lidar sensor for multiple places or uses, the scan angle range being set to the lidar sensor. That is, usages of the lidar sensor may increase.

In an embodiment, a viewer device of the lidar system may detect whether or not an object, e.g. a person, locates in the sensing area by using distance data measured by the lidar sensor, to sense movement of the person including traffic. Since it is detected by using the distance data, the lidar system may have simple and effective structure.

Hereinafter, various embodiments of the disclosure will be described in detail with reference to accompanying drawings.

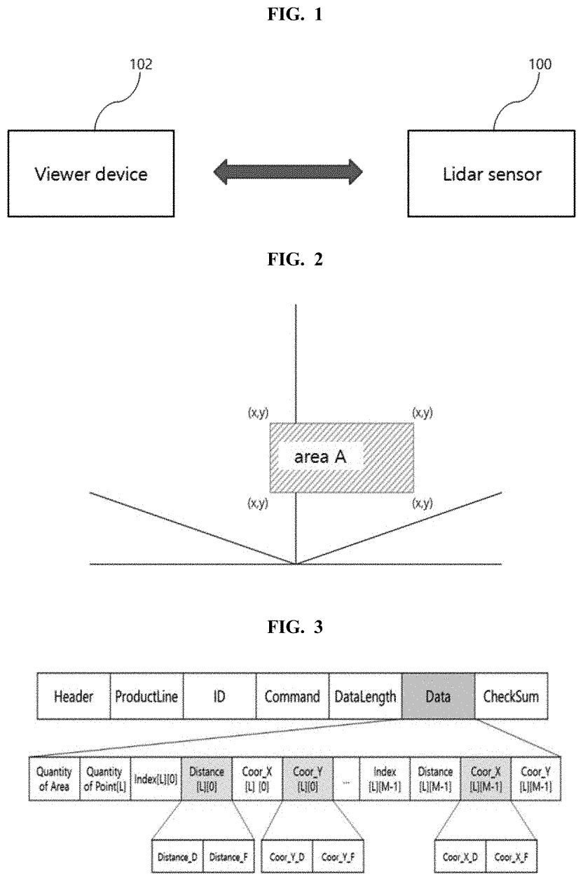

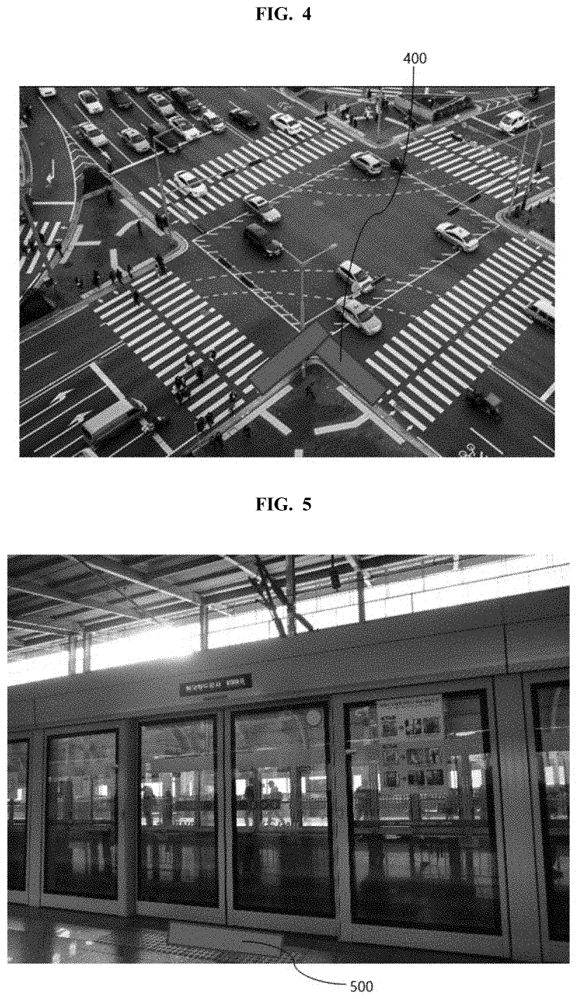

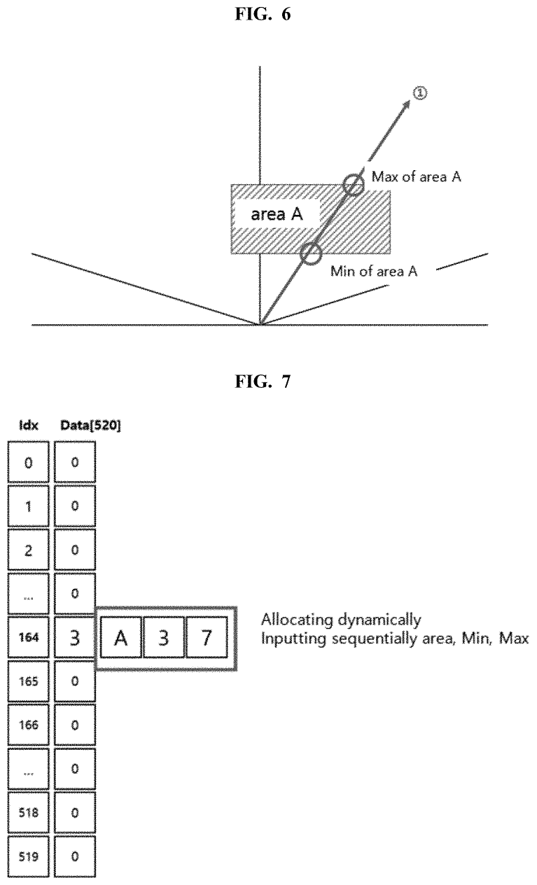

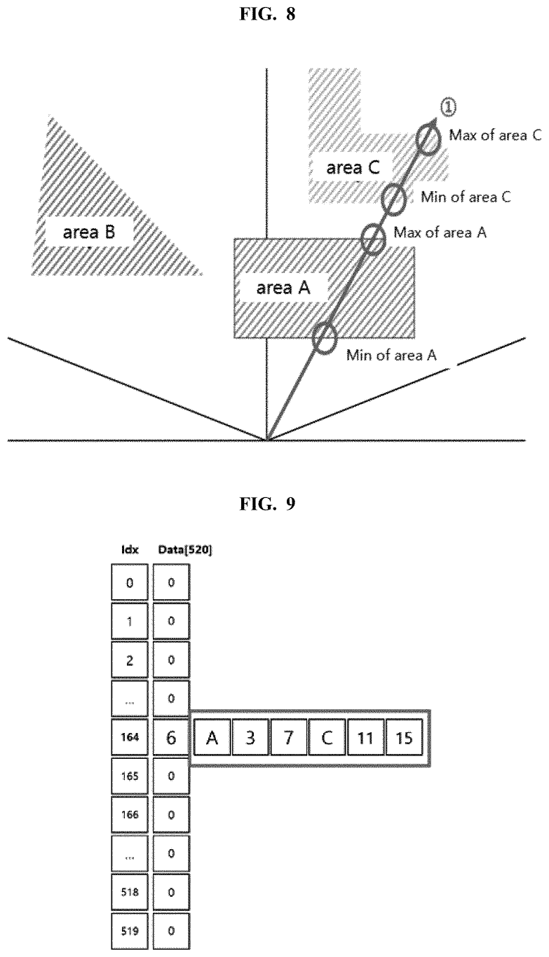

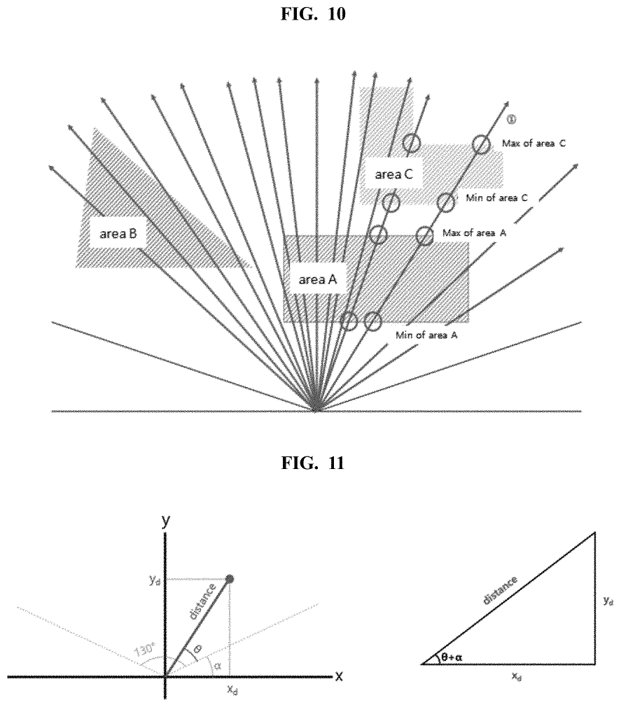

FIG. 1 is a view illustrating a lidar system according to an embodiment of the disclosure, FIG. 2 is a view illustrating a process of setting an area, and FIG. 3 is a view illustrating viewer data according to an embodiment of the disclosure. FIG. 4 and FIG. 5 are views illustrating example of area setting, FIG. 6 is a view illustrating a method of sensing an area by using a distance, and FIG. 7 is a view illustrating an example of a buffer. FIG. 8 is a view illustrating a process of setting plural sensing areas, FIG. 9 is a view illustrating setting of the buffer in FIG. 8, and FIG. 10 is a view illustrating a trigger line. FIG. 11 is a view illustrating a distance conversion process according to an embodiment of the disclosure.

In FIG. 1, a lidar system of the disclosure may include a lidar sensor 100 and a viewer device 102.

The lidar sensor 100 may scan an area in a specific angle range by outputting a light, e.g. a laser, for example scan an area of 130°. However, the lidar sensor 100 may sense only an area designated by a user when the user designates the area though it can scan the area of 130°.

In an embodiment, the lidar sensor 100 may be mounted to a crossroad, a crosswalk or a screen door as well as a vehicle as shown in FIG. 4 and FIG. 5. The lidar sensor 100 may sense people moving through the crosswalk by scanning a crosswalk area 400 when it is mounted to the crosswalk as shown in FIG. 4. Additionally, the lidar sensor 100 may sense people getting in or out of a subway by scanning a bottom area 500 when it is mounted to an upper part of the screen door as shown in FIG. 5.

The lidar sensor 100 may sense only an area in an angle range less than a maximum scan angle to detect the movement of people, etc. passing through a specific sensing area. For example, the lidar sensor 100 mounted to the crossroad may sense a number of people moving through the crossroad in an angle range of 40° when the maximum scan angle of the lidar sensor 100 is 130°. The lidar sensor 100 mounted to the screen door may sense a number of people getting in or out of the subway in an angle range of 30° when the maximum scan angle is 130°. That is, it is possible to use a lidar sensor 100 in multiple angle range in various places. Of course, multiple lidar sensors 100 may be established to a place and sense the sensing area, wherein a part of the sensing area is together sensed by the lidar sensors 100.

The lidar sensor 100 may receive a viewer signal including data concerning a sensing area designated by the user (user designating sensing area) from the viewer device 102, detect the user designating sensing area by analyzing the received viewer signal and scan the detected user designating sensing area.

In an embodiment, the data concerning to the user designating sensing area may be set in an orthogonal coordinate system, and the lidar sensor 100 may convert the data to data in a spherical coordinate system and scan a scan area corresponding to the converted data.

In an embodiment, the lidar sensor 100 may form trigger lines by outputting a laser with various angles in a maximum scan angle range as shown in FIG. 10. Here, a distance (a minimum distance) from the lidar sensor 100 to a start point of a specific sensing area and a distance (maximum distance) from the lidar sensor 100 to an end point of the specific sensing area may be determined based on a specific trigger line, as shown in FIG. 6. To perform this operation, the lidar sensor 100 may be fixedly mounted to a specific place.

In an embodiment, as shown in FIG. 7, a sensing area indicator, the minimum distance and the maximum distance may be dynamically stored in a specific address of a buffer.

Since the minimum distance and the maximum distance of the specific area is determined, it may be detected whether a scanned object locates in the specific sensing area or outside the specific sensing area if a distance between the lidar sensor 100 and the scanned object is known. For example, it is discriminated that the object locates in the specific sensing area if the distance measured by the lidar sensor 100 is 4 when the minimum distance is 3 and the maximum distance is 5 based on the specific trigger line. It is discriminated that the object locates outside the specific sensing area if the distance measured by the lidar sensor 100 is 6 when the minimum distance is 3 and the maximum distance is 5 based on the specific trigger line. However, this discrimination may be performed by the viewer device 102.

It may be discriminated for each of the trigger lines whether or not the object locates in the specific sensing area because the minimum distance and the maximum distance may differ depending on the trigger line.

The viewer device 102 may transmit a viewer signal including data concerning a designated sensing area (sensing area designation data) to the lidar sensor 100 when a user designates the sensing area. Here, the user may designate the sensing area by clicking directly a coordinate of the sensing area desired by the user or designate the sensing area by using a preset figure. The sensing area may be factory-installed. That is, the setting of the sensing area is not limited. This setting may be performed on the spot or be performed for a specific use in a factory.

For example, the user may set a rectangular area A shown in FIG. 2 on the spot or in the factory. This area may be expressed in an orthogonal coordinate system.

In another embodiment, transmitted data may be stored in the lidar sensor 100 when the data concerning the sensing area expressed in the orthogonal coordinate system and designated through the viewer device 102 is transmitted from the viewer device 102 to the lidar sensor 100. The lidar sensor 100 may perform independently a monitoring operation about the sensing area designated by the user though the viewer device 102 is not connected and output a light signal or an electrical signal including a sensed result through a display when the object is sensed.

The viewer device 102 may transmit the sensing area designation data in the orthogonal coordinate system to the lidar sensor 100 when the sensing area is designated, and the lidar sensor 100 may convert the sensing area designation data transmitted from the viewer device 102 into data in the spherical coordinate system and scan corresponding sensing area.

In an embodiment, the lidar sensor 100 may provide an angle measured based on the specific trigger line and a signal arrival time to the viewer device 102, and the viewer device 102 may calculate a distance from the lidar sensor 100 to the sensed object by using the provided angle and the provided signal arrival time. Subsequently, the viewer device 102 may compare the calculated distance with the minimum distance and the maximum data of the specific sensing area and determine whether or not the object locates in the specific sensing area according to the compared result.

In another embodiment, the viewer device 102 may receive distance data from the lidar sensor 100 to the object, compare the received distance data with the minimum distance and the maximum data of the specific sensing area and determine whether or not the object locates in the specific sensing area according to the compared result.

In still another embodiment, the viewer device 102 may receive information as to whether or not the object locates in the sensing area from the lidar sensor 100 and provide the received information to the user through a screen.

On the other hand, the viewer device 102 may detect whether or not the object locates in the specific sensing area, a moving direction of the object, a number of the object, etc.

Hereinafter, an operation of the lidar sensor 100 and the viewer device 102 will be described in detail.

In FIG. 6 to FIG. 10, the viewer device 102 may store a sensing area indicator and the minimum distance Min and the maximum distance Max based on a trigger line \textcircled{1} in a specific address of a buffer as shown in FIG. 7 when it transmits the viewer signal including the sensing area designation data shown in FIG. 2 to the lidar sensor 100. Here, the specific address may be dynamically allocated.

Additionally, the viewer device 102 may store sequentially a sensing area indicator, a minimum distance and a maximum distance for each of sensing areas based on the same trigger line in a buffer as shown in FIG. 9 when a user sets multiple sensing areas as shown in FIG. 8. This is, the viewer device 102 may allocate sensing area data. Here, the sensing areas may be dynamically allocated in an address of the buffer.

For example, a name, a minimum distance and a maximum distance of an A sensing area and a name, a minimum distance and a maximum distance of a C sensing area may be sequentially allocated in one address when the same trigger line \textcircled{1} is pass through the A sensing area and the C sensing area. Here, a distance between the C sensing area and a location of the lidar sensor 100 (a central point in FIG. 8) is higher than that between the A sensing area and the location of the lidar sensor 100, and thus the minimum distance of the C sensing area may be greater than the maximum distance of the A sensing area. For example, the minimum distance of the C sensing area may be 11 when the maximum distance of the A sensing area is 7.

Only one trigger line is mentioned in above description. However, multiple trigger lines may exist in a scan angle range of the lidar sensor 100 as shown in FIG. 10. Here, a minimum distance and a maximum distance for each of sensing areas may be set based on each of the trigger lines.

Subsequently, the lidar sensor 100 may calculate a distance of a sensed object after converting a spherical coordinate system (r, ⊖) including a distance r and an angle ⊖ sensed in a predetermined sensing area into an orthogonal coordinate system, and detect whether or not the sensed object locates in the sensing area by comparing the calculated distance with a minimum distance and a maximum distance of corresponding trigger line.

In the above description, the process of allocating the sensing area data to the buffer, the process of calculating the distance after converting the distance r and the angle ⊖ sensed by the lidar sensor 100 to in the orthogonal coordinate system and the process of detecting whether or not the object locates in the sensing area by comparison of the distances are performed by the lidar sensor 100. However, at least one of the processes may be performed by the viewer device 102 not the lidar sensor 100.

In another embodiment, the process of calculating the distance may be performed by the lidar sensor 100, and the process of allocating the sensing area data and the process of detecting whether or not the object locates in the sensing area may be performed by the viewer device 102.

In FIG. 11, the viewer device 102 may convert data about the distance of the sensed object transmitted from the lidar sensor 100 into a point coordinate (x_{d}, y_{d}) and output the point coordinate (x_{d}, y_{d}) on a screen.

The color of corresponding point may be changed in the viewer device 102 and the lidar sensor 100 may output extra pulse to notify to the user, when the object is sensed in the sensing area.

On the other hand, in the event that the user sets the sensing area, the viewer device 102 may transmit an angle, a distance and an orthogonal coordinate corresponding to a trigger line about the set sensing area to the lidar sensor 100.

Hereinafter, the lidar sensor 100 and the viewer device 102 will be described in detail.

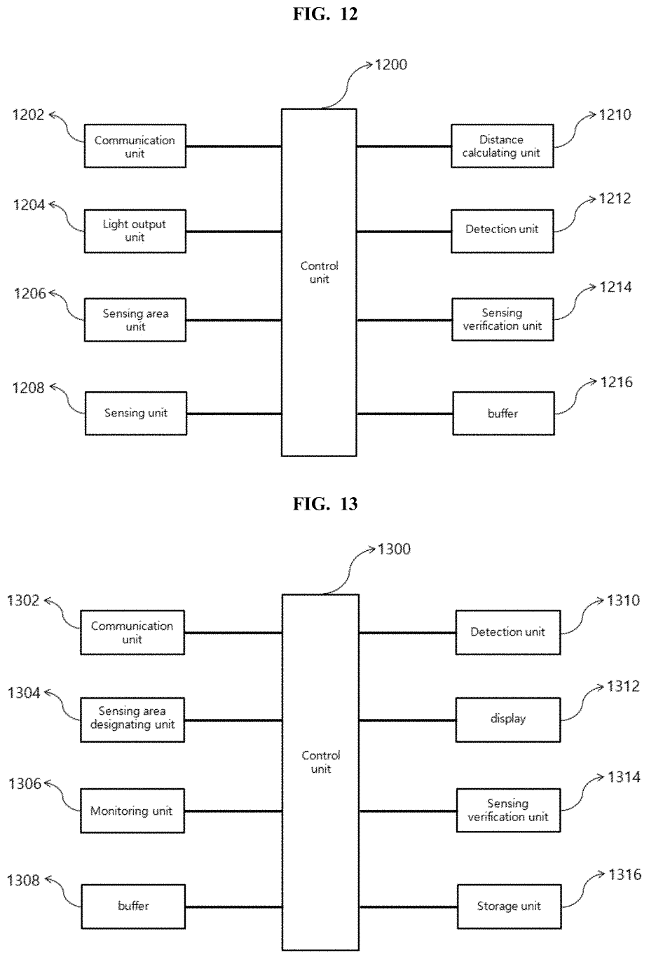

FIG. 12 is a block diagram illustrating a lidar sensor according to an embodiment of the disclosure, and FIG. 13 is a block diagram illustrating a viewer device according to an embodiment of the disclosure.

In FIG. 12, the lidar sensor 100 of the present embodiment may include a control unit 1200, a communication unit 1202, a light output unit 1204, a sensing area unit 1206, a sensing unit 1208, a distance calculating unit 1210, a detection unit 1212, a sensing verification unit 1214, a buffer 1216 and a storage unit (not illustrated in FIG. 12).

The communication unit 1202 is a communication path with the viewer device 102.

The light output unit 1204 may output a light to a sensing area set by a user. Specially, the light output unit 1204 may output a light in a specific angle corresponding to a trigger line so that the trigger line passes through the sensing area.

The sensing area unit 1206 may manage a sensing area set by a user and transmitted from the viewer device 102 through the communication unit 1202, specially set a minimum distance from the lidar sensor 100 to the sensing area and a maximum distance from the lidar sensor 100 to the sensing area. Here, the sensing area means an area in a maximum scan angle range.

The sensing unit 1208 may sense an object in the sensing area by using a reflection light reflected by the object. In an embodiment, the sensing unit 1208 may obtain a measured angle of the object and a light arrival time (a time from when the light is outputted to when the reflected light is received).

The distance calculating unit 1210 may calculate a distance from the lidar sensor 100 to the object by using the obtained measured angle and the light arrival time.

The detection unit 1212 may detect whether or not the object locates in the sensing area by comparing the calculated distance with a minimum distance and a maximum distance of the sensing area.

In the event that multiple sensing areas are designated by the user, e.g. a first sensing area and a second sensing area are designated, the detection unit 1212 may detect whether or not an object locates in the first sensing area and the second sensing area by comparing the calculated distance with a minimum distance and a maximum distance of the first sensing area and a minimum distance and a maximum distance of the second sensing area. Here, the same trigger line may pass through the first sensing area and the second sensing area.

The sensing verification unit 1214 may output a specific pulse or light when the object is sensed in the sensing area.

The buffer 1216 may store the minimum distance and the maximum distance of the sensing area in an address allocated dynamically. Specially, the buffer 1216 may store sequentially minimum distances and maximum distances of plural sensing areas corresponding to the same trigger line in the same address.

The storage unit may store information such as data about the sensing area and so on.

The control unit 1200 controls operation of elements of the lidar sensor 100.

In the above description, the lidar sensor 100 detects whether or not the object locates in the sensing area. However, the lidar sensor 100 may transmit distance data to the viewer device 102 and the viewer device 102 may detect whether or not the object locates in the sensing area. In this case, the lidar sensor 100 may not include the detection unit 1212 and the buffer 1216.

In FIG. 13, the viewer device 102 may include a control unit 1300, a communication unit 1302, a sensing area designating unit 1304, a monitoring unit 1306, a buffer 1308, a detection unit 1310, a display 1312, a sensing verification unit 1314 and a storage unit 1316.

The communication unit 1302 is a communication path with the lidar sensor 100. For example, the communication unit 1302 may transmit data concerning a sensing area designated by a user in an orthogonal coordinate system to the lidar sensor 100 and receive information concerning an object sensed in the sensing area from the lidar sensor 100.

The sensing area designating unit 1304 may manage the sensing area designated by the user. For example, the sensing area designating unit 1304 may manage a minimum distance and a maximum distance of the designated sensing area. Here, the user may set the sensing area by clicking directly a coordinate of a desired area or by using a figure.

The monitoring unit 1306 may provide the sensing area sensed through the lidar 100 to the user through the display 1312. That is, the user may monitor the designated sensing area through the monitoring unit 1306.

The buffer 1308 may store the minimum distance and the maximum distance of the sensing area in its address allocated dynamically. Specially, the buffer 1308 may store sequentially minimum distances and maximum distances of multiple sensing areas corresponding to the same trigger line in the same address.

The detection unit 1310 may detect whether or not the object locates in the sensing area by comparing a distance to the object measured by the lidar sensor 100 with the minimum distance and the maximum distance of the sensing area.

In the event that the sensing areas are designated by the user, e.g. a first sensing area and a second sensing area are designated, the detection unit 1310 may detect whether or not the object locates in the first sensing area and the second sensing area by comparing the calculated distance with a minimum distance and a maximum distance of the first sensing area and a minimum distance and a maximum distance of the second sensing area. Here, the same trigger line may pass through the first sensing area and the second sensing area.

The sensing verification unit 1314 may change the color of a point showing the sensing area or the object when the object is sensed in the sensing area.

The storage unit 1316 may store information such as distance data, etc.

The control unit 1300 controls an operation of elements of the viewer device 102.

Components in the embodiments described above can be easily understood from the perspective of processes. That is, each component can also be understood as an individual process. Likewise, processes in the embodiments described above can be easily understood from the perspective of components.

Also, the technical features described above can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the invention, and vice versa.

The embodiments of the invention described above are disclosed only for illustrative purposes. A person having ordinary skill in the art would be able to make various modifications, alterations, and additions without departing from the spirit and scope of the invention, but it is to be appreciated that such modifications, alterations, and additions are encompassed by the scope of claims set forth below.

1. A lidar sensor comprising:
a sensing area unit configured to set a sensing area in a maximum scan angle range and manage the set sensing area;
a light output unit configured to output a light with a specific angle so that the light is outputted to a specific sensing area; and
a sensing unit configured to sense an object in the specific sensing area by using a reflection light of the outputted light,
wherein the outputted light forms a trigger line, the sensing unit obtains a measured angle and a light arrival time of the sensed object based on the trigger line, and a minimum distance and a maximum distance from the lidar sensor to the specific sensing area are set based on the trigger line.

2. The lidar sensor of claim 1, wherein the lidar sensor communicates with a viewer device,
and wherein the lidar sensor senses the object by outputting a light to a designated specific sensing area when a user designates the specific sensing area by using the viewer device,
the lidar sensor further includes a distance calculating unit for calculating a distance to the object by using the obtained measured angle and the obtained light arrival time and a detection unit for detecting whether or not the object locates in the specific sensing area by comparing the calculated distance with the minimum distance and the maximum distance.

3. The lidar sensor of claim 2, further comprising:
a sensing verification unit configured to output a specific pulse or a light when the object is sensed in the specific sensing area.

4. The lidar sensor of claim 2, wherein a minimum distance and a maximum distance of a first sensing area and a minimum distance and a maximum distance of a second sensing area are set when the first sensing area and the second sensing area are designated by the user based on the trigger line,
and wherein the minimum distance of the second sensing area is higher than the maximum distance of the first sensing area, and
the detection unit detects whether or not the object locates in the first sensing area and the second sensing area by comparing the calculated distance with the minimum distance and the maximum distance of the first sensing area and the minimum distance and the maximum distance of the second sensing area.

5. The lidar sensor of claim 4, further comprising:
a buffer configured to store the minimum distances and the maximum distances,
wherein an indicator for the first sensing area, the minimum distance and the maximum distance of the first sensing area, an indicator for the second sensing area, the minimum distance and the maximum distance of the second sensing area are sequentially stored in a specific address of the buffer, and the specific address is dynamically allocated.

6. The lidar sensor of claim 1, wherein the lidar sensor mounted to a crossroad, a crosswalk or a screen door senses the specific sensing area,
and wherein the lidar sensor detects movement including traffic of people passing through the specific sensing area.

7. The lidar sensor of claim 1, wherein the lidar sensor communicates with a viewer device,
and wherein the lidar sensor senses an object by outputting a light to a designated specific sensing area when a user designates the specific sensing area by using the viewer device,
the lidar sensor further includes a distance calculating unit for calculating a distance to the object by using the obtained measured angle and the obtained light arrival time and a communication unit for transmitting data concerning the calculated distance to the viewer device, and
the viewer device detects whether or not the object locates in the specific sensing area by comparing the calculated distance with the minimum distance and the maximum distance.

8. The lidar sensor of claim 7, wherein a transmitted data is stored in the lidar sensor when the data concerning the specific sensing area designated through the viewer device in an orthogonal coordinate system is transmitted from the viewer device to the lidar sensor, and the lidar sensor performs independently a monitoring operation of the designated specific sensing area though the lidar sensor is not connected to the viewer device and outputs a light signal or an electrical signal including a sensed result through a display when the object is sensed.

9. A viewer device comprising:
a sensing area designating unit configured to manage a sensing area designated by a user;
a communication unit configured to transmit data concerning the designated sensing area in an orthogonal coordinate system to the lidar sensor and receive information concerning an object sensed in the sensing area from the lidar sensor; and
a monitoring unit configured to monitor the sensing area based on the received information.

10. The viewer device of claim 9, wherein the user sets the sensing area by clicking directly a coordinate of a desired area or by using a figure.

11. The viewer device of claim 9, wherein the communication unit receives distance data from the lidar sensor to the sensed object from the lidar sensor, the monitoring unit outputs the received distance data as a point on a screen, and
a color of the sensing area or the point is changed when the object is sensed in the sensing area.

12. The viewer device of claim 9, wherein the communication unit receives information concerning a measured angle from the lidar sensor to the object and a light arrival time,
a light outputted to the sensing area by the lidar sensor forms a trigger line, a minimum distance and a maximum distance from the lidar sensor to the sensing area are set based on the trigger line,
the viewer device further includes a distance calculating unit for calculating a distance from the lidar sensor to the object by using the measured angle and the light arrival time and a detection unit for detecting whether or not the object locates in the sensing area by comparing the calculated distance with the minimum distance and the maximum distance.

13. The viewer device of claim 9, wherein the communication unit receives information concerning a distance from the lidar sensor to the object,
a light outputted to the sensing area by the lidar sensor forms a trigger line, a minimum distance and a maximum distance from the lidar sensor to the sensing area are set based on the trigger line,
the viewer device further includes a detection unit for detecting whether or not the object locates in the sensing area by comparing the distance to the object with the minimum distance and the maximum distance.

14. The viewer device of claim 9, wherein a minimum distance and a maximum distance of a first sensing area and a minimum distance and a maximum distance of a second sensing area are set when the first sensing area and the second sensing area are designated by the user based on the trigger line, and
the viewer device detects whether or not the object locates in the first sensing area or the second sensing area by comparing the distance from the lidar sensor to the object with the minimum distance and the maximum distance of the first sensing area or the minimum distance and the maximum distance of the second sensing area.

15. The viewer device of claim 14, further comprising:
a buffer configured to store the minimum distances and the maximum distances,
wherein the minimum distance and the maximum distance of the first sensing area and the minimum distance and the maximum distance of the second sensing area are sequentially stored in a specific address of the buffer, and the specific address is dynamically allocated.
